(19) United States
(12) Patent Application Publication
(10) Pub. No.: US 2020/0191628 A1
(43) Pub. Date: Jun. 18, 2020

(54) MEASURING DEVICE FOR DETERMINING A FLUID VARIABLE

(71) Applicant: DIEHL METERING GMBH, ANSBACH (DE)

(72) Inventors: ANDREAS BENKERT, ANSBACH (DE); THOMAS STURM, SACHSEN (DE); MICHAEL MAYLE, ANSBACH (DE); PETER PLOSS, BAYREUTH (DE)

(21) Appl. No.: 16/675,281

(22) Filed: Nov. 6, 2019

(30) Foreign Application Priority Data
Dec. 12, 2018 (DE) 102018009754.5

(51) Int. Cl. G01F 1/66; G01P 5/24

(52) U.S. Cl. CPC G01F 1/667; G01P 5/245; G01F 1/662

(57) ABSTRACT

A measuring device determines a fluid variable via a control device. A measuring tube serves to guide the fluid, and a first vibration transducer is arranged at the measuring tube. The first vibration transducer has a supporting device and two vibration elements spaced apart from one another. A spring element is clamped between a side face of the vibration elements averted from the measuring tube, which presses the respective vibration element against the measuring tube. The control device drives the vibration elements such that they excite a guided wave in a side wall of the measuring tube guided directly in the side wall or indirectly via the fluid to a second vibration transducer arranged at the measuring tube or back to the first vibration transducer, to be detected there by the control device resulting in measurement data. The control device determines the fluid variable depending on the measurement data.

### CROSS-REFERENCE TO RELATED APPLICATION

This application claims the priority, under 35 U.S.C. § 119, of German application DE 10 2018 009 754.5, filed Dec. 12, 2018; the prior application is herewith incorporated by reference in its entirety.

### BACKGROUND OF THE INVENTION

### Field of the Invention

The invention relates to a measuring device for determining a fluid variable relating to a fluid and/or a fluid flow of the fluid, with a control device, a measuring tube that serves to accommodate and/or guide the fluid, and a first vibration transducer arranged at the measuring tube.

Ultrasonic counters are one possible way of detecting a flow rate or another measured variable relating to a fluid. These use at least one ultrasonic transducer in order to couple an ultrasonic wave into the fluid flowing through the measuring tube, wherein this is guided to a second ultrasonic transducer on a direct path or after a plurality of reflections at walls or special reflection elements. A speed of the flow through the measuring tube can be determined from the transit time of the ultrasonic wave between the ultrasonic transducers, or from a transit time difference when the transmitter and receiver are exchanged.

The use of a so-called interdigital transducer to excite guided waves, wherein a piezoelectric element having comb-like, intermeshing control lines is used to achieve an excitement of specific excitation modes of guided waves is known from the article by G. Lindner, “Sensors and Actuators Based on Surface Acoustic Waves Propagating along Solid-Liquid Interfaces”, J. Phys. D: Appl. Phys. 41 (2008) 123002. Since shear modes of the piezoelectric element are necessarily excited, the excitation typically does not achieve high efficiencies. A relatively complex, highly precise lithography is, furthermore, necessary in order to apply the necessary electrode structure exactly enough, wherein sufficient modal purity of the excitation is, nevertheless, often not achieved.

Excitation of a modally pure guided wave is nevertheless highly relevant for use in an ultrasonic counter, since the angle at which compression vibrations are radiated into the fluid depends on the phase velocity of the guided wave which typically is different in different excitation modes at the same excited frequency. If different modes are excited, different propagation paths result for the compression vibrations in the fluid which can, at best, be computationally removed through a complex signal evaluation.

### SUMMARY OF THE INVENTION

The invention is therefore based on the object of providing a measuring device that uses guided waves for measurement, wherein a low space requirement and a simple construction of the measuring device used should be realized.

The object is achieved according to the invention by a measuring device of the type mentioned at the beginning, wherein a first vibration transducer contains a supporting device in a location that is fixed with respect to the measuring tube and at least two vibration elements spaced apart from one another. At least one or at least one respective, elastically deformed spring element is clamped between a respective side face of the vibration elements averted from the measuring tube and the supporting device, which presses the respective vibration element against the measuring tube or a coupling element arranged between the measuring tube and the respective vibration element. The control device is configured to drive the vibration elements in such a way that together they excite a guided wave in a side wall of the measuring tube that can be guided directly in the side wall or indirectly via the fluid to a second vibration transducer arranged at the measuring tube or back to the first vibration transducer, in order to be detected there by the control device for the determination of measurement data. The control device is configured to determine the fluid variable depending on the measured data.

It is proposed that one wall of a measuring tube is excited by a plurality of vibration elements spaced apart from one another and thus in spaced excitation regions. By overlaying the generated partial waves, a total wave is generated that can then be used for measurement. The geometric arrangement of the vibration elements or of the excitation regions, and the parameters of the vibration excitation, that is to say in particular a frequency used and a polarity and/or phase relation, that is used to operate the individual vibration elements, are matched to one another in such a way that a vibration mode that is to be attenuated is attenuated, or substantially entirely eliminated, through a destructive interference, at least for one direction of propagation. A high modal purity of the excitation can be achieved in this way, in that an unwanted vibration mode is specifically attenuated.

It is nevertheless highly relevant to the use of this excitation principle, that the vibration elements are correctly positioned with respect to one another. A supporting device is used for this purpose in the measuring device according to the invention. A spring element, or a respective spring element, is used between the supporting device and the vibration elements, each of the vibration elements is pressed with a defined pressure against the side wall of the measuring tube or against a coupling element arranged between the vibration element and the measuring tube. A large number of advantages are achieved through supporting the vibration elements at the measuring tube in this way. Firstly, tolerances resulting from production can be compensated for, since, through the mounting using at least one spring element it is firstly ensured that in spite of production tolerances that typically can never be entirely avoided, the vibration element is in good contact with the measuring tube or with the coupling element, and secondly the possibility that excessively large forces which could, for example, destroy a piezoceramic vibration element act on the vibration element is avoided. In addition to tolerances that concern the purely geometrical dimensions of the measuring device, this procedure can also compensate for irregularities of the side wall, the vibration elements and/or the supporting device. The possibility that the piezoelectric elements are tilted against the measuring tube during assembly of the measuring device, and that a non-planar contact between these components therefore results, is also prevented. In addition, as already explained, a defined positioning of the individual elements and a defined pressing force is achieved with low technical effort. The mounting by means of at least one spring element can also effect an acoustic attenuation, which firstly can have a positive effect on the vibration behavior of the vibration elements, since narrow-band resonance peaks and tendencies to reverberate are reduced. Secondly, the coupling of vibrations into the supporting device, i.e. for example into a transducer housing, is reduced.

The supporting device can, in particular, be configured as a housing which, together with the measuring tube or the coupling element, for example as explained later in detail, with a vibration plate or vibration foil that surrounds the vibration elements on all sides. The vibration elements can hereby be protected against environmental influences, for example in that a fluid-proof or at least splash-proof housing is used.

The use of two or more vibration elements that perform an excitation in separate excitation regions is advantageous, since, in the case of the excitation of a guided Lamb wave in the side wall of the measuring tube, at least two modes can always be excited at a specific excitation frequency. Through the selection of a suitable excitation frequency, it is possible to ensure that precisely two vibration modes can be excited, namely an asymmetric and a symmetric Lamb wave. Since these vibration modes have different phase velocities, they also have different wavelengths, so that through an appropriate choice of the distances between the excitation regions and an appropriate delay of the excitation signals used for one of the vibration elements, or through the choice of an appropriate phase relation and/or polarity of the excitations, a substantially completely destructive interference of the unwanted mode, and thus a modally pure excitation, can be achieved.

Through the method according to the invention, measurements can be taken at a fluid flow flowing through the measuring tube, but also at a fluid that is stationary in the measuring tube. The use of a vibration transport for the detection of fluid properties is known, in principle, in the prior art. For example, transit time differences in the transit time of a vibration between a first and second ultrasonic converter and vice versa are detected in ultrasonic counters, and a fluid velocity can be determined from that. Other measurement data can, however, also be evaluated in order to determine fluid properties. A signal amplitude at the receiving vibration transducer can, for example, be evaluated in order to detect an attenuation of the vibration during transport through the fluid. Amplitudes can also be evaluated in a frequency-dependent manner, and absolute or relative amplitudes of specific spectral regions can be evaluated in order to detect a spectrally varied attenuation behavior in the fluid. Phase relations of different frequency bands can also be evaluated in order, for example, to obtain information about the dispersion behavior of the measuring section. Information about the dispersion behavior of the pressure wave in the fluid and/or about the dispersion behavior of the Lamb wave in the wall can preferably be determined. Alternatively or in addition, changes over time, for example within one measuring pulse, in the spectral composition or the amplitude can be evaluated.

Through the evaluation of these variables, flow velocity and/or a flow volume and/or density, temperature and/or viscosity of the fluid can, for example, be determined as fluid variables. In addition or as an alternative, a speed of sound in the fluid and/or a composition of the fluid, for example a mixing ratio between different components, can, for example, be determined. Different approaches to obtaining these fluid variables from the measured variables referred to above are known in the prior art, and will not therefore be presented in detail. Relationships between one or a plurality of measured variables and the fluid variable can, for example, be determined empirically, and a look-up table or a corresponding formula can, for example, be used in order to determine the fluid variable.

The spring element can in particular be clamped between the side face of the respective vibration element averted from the measuring tube and a surface of the supporting device that is parallel thereto. The vibration element can, for example, have the form of an elongated rectangle, wherein the longest side of the vibration element can extend perpendicularly to a desired direction of propagation of the guided wave, for example in the transverse direction of the measuring tube. The two vibration elements can be arranged parallel to one another at a specific spacing in the direction of propagation of the guided wave. If a fixed frequency is used in the measuring device for excitation of the vibration elements, a spacing that corresponds, for example, to the wavelength or to half of the wavelength of a vibration mode that is to be attenuated can be used. With a spacing of one half of a wavelength an attenuation occurs when the vibration elements are operated with the same polarity, and with a spacing of an entire wavelength, this occurs when operated with different polarity.

At least one of the vibration elements can comprise a vibration body, an electrode at the measuring tube side that is arranged on a side face of the respective vibration body on the measuring tube side, and an electrode averted from the measuring tube that is arranged at a side face of the vibration body averted from the measuring tube on the opposite side to the side face on the measuring tube side. The electrode on the measuring tube side extends over a further side face of the vibration body that is angled with respect to the side faces on the measuring tube side and averted from the measuring tube. The control device is configured to vary a voltage between the electrodes on the measuring tube side and averted from the measuring tube in order to excite the vibration body into vibration. By guiding the electrode on the measuring tube side on a further side face, contacting this electrode is significantly simplified.

The electrode averted from the measuring tube preferably also extends over a further side face that is angled with respect to the side faces on the measuring tube side and averted from the measuring tube, in particular on a side face that is positioned opposite to that side face on which the measuring tube side electrode extends. The side faces over which the electrodes extend can, for example, be the two side faces in the transverse direction of the measuring tube. It was established in the context of the invention that an asymmetrical electrode structure in which exclusively one of the electrodes is guided at least partially around the vibration body affects the natural modes of the vibration element in a way that can be detrimental to the desired most modally pure excitation of guided waves. First an asymmetry in the mechanical properties of the vibration element and, second, an asymmetric field distribution in the vibration body when a voltage is applied to the electrodes result from an asymmetric arrangement of the electrodes. It has been recognized that even in the case in which a substantially plane guided wave is excited perpendicularly to the direction in which this asymmetry is found, such an asymmetry can prevent a modally pure excitation, or at least make it more difficult. It has, however, been recognized that such an asymmetry can be overcome in that the electrode averted from the measuring tube also extends over a further side face of the vibration body. The symmetry of the electrodes, and thereby the symmetry of the entire vibration element, can be increased by this, which is advantageous for the excitation of modally pure vibrations.

The vibration body can consist of a piezoelectric material, for example of piezoceramic, and can in particular be rectangular.

The electrode on the measuring tube side can extend over the further side face as far as the side face averted from the measuring tube. As explained above, it is advantageous if a symmetrical electrode arrangement is used, so that it can additionally be provided that the electrode averted from the measuring tube extends over the corresponding further side face as far as the side face that faces the measuring tube. Such a design of the measuring device has a number of advantages. First, in the edge regions in which the same electrode is arranged on both the side face averted from the measuring tube as well as the side face that faces the measuring tube, regions of the vibration body result that are approximately without field even when voltage is applied, whereby only small vibration amplitudes occur in these regions. These regions are thus well-suited to supporting and/or contacting the vibration elements. Second the electrode arrangement makes it possible for both electrodes to be contacted on the side face averted from the measuring tube, which can further simplify the contacting, in particular if, as will be explained later in more detail, spring elements are used for contacting.

It is possible that two or more spring elements which mechanically contact the side faces of the respective vibration element that are averted from the measuring tube in a respective contact region with the side face averted from the measuring tube are arranged between a respective vibration element and the supporting device. This can be advantageous if the spring elements should serve for contacting the electrodes and/or if the mounting is to be matched to the concrete vibration behavior of the vibration element, as will again be explained later.

The electrode averted from the measuring tube and/or the electrode on the measuring tube side can be electrically contacted by a respective spring element that is electrically conductive. A metal spring or a conductive plastic can, for example, be used as a conductive spring element. The spring element can contact the vibration element mechanically in a region in which the corresponding electrode is also arranged, whereby an electrical contact also results. An application of voltage by the control device for the excitation of vibrations is possible through such a contact. It is also possible to connect one of the electrodes to a reference potential, for example a ground potential, through such a contact. A contact via conductive spring elements preferably takes place in the region of the side face of the vibration element averted from the measuring tube. It would, for example, be possible as an alternative to this to use separate contact elements which could, for example, touch the vibration element at the front end.

An electrically conductive spring element refers in particular to a spring element that conducts sufficiently well for an application of voltage to the electrodes for the excitation of vibration to be possible via the spring element. The spring element can, for example, have a total resistance of less than 100 Ω, or can consist of a material with a specific resistance of less than 0.1 Ω/m, in particular of less than 10⁻³ Ω/m or of less than 10⁻⁴ Ω/m.

At least one of the spring elements can electrically contact precisely one electrode of precisely one of the vibration elements. As an alternative to this it would, for example, be possible for a spring element to contact a respective electrode of both vibration elements. This can indeed be advantageous in order to pull a respective electrode of both vibration elements to a defined reference potential or to feed the same drive signal to a respective electrode of both vibration elements. Frequently, however, it is advantageous to be able to drive the vibration elements in different ways. This is made possible in that at least one electrode of the vibration elements is contacted separately for each of the vibration elements.

The ability to drive the vibration elements separately can, for example, serve to supply a drive signal used to drive a first of the vibration elements to a further vibration element with a predefined time delay. If the time delay is chosen, for example, in such a way that it corresponds to a transit time of a particular vibration mode, it is possible to ensure that the second vibration element vibrates in phase with the incoming wave from the first vibration element or, through an inversion of the drive polarity, to arrange that it vibrates in anti-phase, with which the corresponding vibration mode is to a large extent entirely eliminated. Through the choice of the delay time it is thus possible to determine which of the vibration modes in the total wave excited by the individual vibration elements is eliminated through destructive interference, so that, in particular when the excitation frequency is selected such that only precisely two vibration modes are excited, optionally an excitation that is mode-selective, or to a large extent modally pure, of a selected one of these modes can then occur.

In an alternative form of embodiment it would, for example, be possible to choose the excitation frequency such that, in accordance with the dispersion relation of the side wall, a mode that can be excited at this frequency has precisely twice the wavelength of the other excitable mode. If the distance between the centers of the excitation regions, or the centers of the vibration elements, is now selected such that it corresponds to the wavelength of the shorter of these waves, then in the case of synchronous excitation of the two vibration elements with the same polarity, a largely modally pure excitation of the shorter-wave mode results, and in the case of excitation with inverted polarity, a largely modally pure excitation of the longer-wave mode.

The vibration body can be rectangular, wherein the side faces on the measuring tube side and averted from the measuring tube are spanned by a longitudinal direction and a transverse direction of the rectangle. The vibration body has a first edge region at a first edge in the transverse direction and a second edge region at a second edge positioned opposite. Wherein in the first edge region only the electrode on the measuring tube side is arranged both at the side face on the measuring tube side and at the side face averted from the measuring tube, and in the second edge region only the electrode averted from the measuring tube is arranged both at the side face on the measuring tube side and at the side face averted from the measuring tube. A respective spring element mechanically contacts the side face of the vibration elements averted from the measuring tube in the first and second edge region. Since the same electrode is arranged in the edge regions on both sides of the vibration body, only very low field strengths occur in these regions even when a voltage is applied between the electrodes. Thus if the vibration element is excited into vibrations through an application of voltages, only very small vibration amplitudes result in the edge regions. Mounting the vibration element in these regions thus has the result that firstly the natural vibrations of the vibration element are not disturbed to any significant extent through this mounting and, secondly, hardly any vibration is input into the supporting device, i.e. for example in a measuring device housing. With the arrangement of the spring elements it is, moreover, possible to achieve a contacting of the two electrodes with little effort if conductive spring elements are used.

Alternatively, one or a respective spring element can contact the side face of the respective vibration element averted from the measuring tube at a plurality of spaced contact regions. The contact regions are each arranged in the region of a vibration node of a natural vibration of the respective vibration element. An influence of the mounting on the vibration behavior of the vibration element can be minimized in this way. The control device is preferably configured such that when the measuring device is used for the excitation of the guided wave, it is precisely this natural vibration of the respective vibration element that is excited.

The spring element or at least one of the spring elements and/or the supporting device can comprise at least one stop section that mechanically contacts one of the vibration elements on at least one side face of the vibration element that is angled with respect to the side face averted from the measuring tube, and/or that limits a movement of the vibration element perpendicularly to this side face at least on one side. The corresponding side face can in particular be a side face at which none of the electrodes are arranged. The stop section can, for example, serve as a stop in the direction in which the vibration elements are spaced or in which a propagation of the guided wave should take place, i.e. for example in a longitudinal direction of the measuring tube. A corresponding stop section can thus primarily serve to ensure a correct spacing of the vibration elements during construction of the measuring device. The stop can, for example, be spaced less than 5 mm, less than 1 mm or less than 0.5 mm from the corresponding side face, or can touch it directly. Corresponding stop sections can preferably be provided on at least two mutually opposing sides of the vibration element.

The spring element, or at least one of the spring elements, can have a recess into which one of the vibration elements is inserted in such a way that a contact section of the spring element lies against the side face of the vibration element averted from the measuring tube, and that at least one supporting section that extends in the direction of the measuring tube over and beyond the contact section forms the stop section. In particular, two supporting sections of a spring element can extend on mutually opposing sides of the vibration element over and beyond the contact section, in order to form stops for the vibration element on both sides. A robust positioning of the vibration element can thus be achieved with very little effort, for example by cutting an appropriate recess into a metal sheet acting as the spring element.

The spring element can be formed of a polymer or an elastomer or a metal, or can be an adhesive material or can comprise an adhesive material. Standard components such as O-rings or flat gaskets made of elastic materials can, for example, be used as the spring element. It is also possible to use cuttings from elastomer straps or sealing cords as spring elements. The spring element can be laid flat under the vibration element, i.e. substantially over the whole of the side face averted from the measuring tube, or only in partial regions, for example, as explained, in the edge region or under vibration nodes.

It is possible for a common spring element to be used for both vibration elements. Alternatively, precisely one spring element can be used for each of the vibration elements, or a plurality of spring elements can be used for each of the vibration elements.

The spring element can be configured as a separate component. It is, however, also possible that the spring element is manufactured in the course of the construction of the measuring device together with the supporting device, i.e. for example a housing or together with the single vibration element, or can be applied to these components in a preparatory step. An elastomer layer can, for example, be sprayed onto the supporting device or onto the vibration element. Elastic adhesive materials or self-adhesive, flexible components, an adhesive tape for example, can also be applied to the measuring device or the vibration elements before the components are brought together. Through the application of the spring element onto the vibration element as a layer, a desired orientation of the vibration element can be clearly predefined even before the measuring device is assembled. This is in particular relevant if the vibration element should be attached to the supporting device with a defined polarity. A colored or otherwise easily visually recognizable layer can, for example, be applied to the vibration element as the spring element for clear identification.

The spring element can, for example, also be a stamped and bent metal part. Bent up flaps can be used here as the stop region, in order to specify the position of the vibration element, and an elastic effect can be realized by elevations, manufactured through bending, on the side of the vibration element averted from the measuring tube. These can, for example, as explained earlier, be arranged in the region of vibration nodes in order to achieve free vibration of the vibration element in the central region. An electrical contacting of an electrode of each vibration element can also take place through these elevations. The remaining electrode can, for example, be contacted at a side face that is angled with respect to the side face averted from the measuring tube.

The first vibration transducer can comprise a vibration membrane or a vibration plate as a coupling element that is fastened to the supporting device and coupled to the measuring tube directly or via a coupling layer. A respective vibration element is arranged at the surface of the vibration membrane or vibration plate averted from the measuring tube at mutually spaced excitation regions, wherein the vibration elements are supported jointly by the, or the respective, spring element and the vibration membrane or the vibration plate. Several advantages are achieved in this way. First it is made possible for the vibration elements to be fully enclosed by the supporting device and the vibration membrane or vibration plate, so that, for example, protection against water splash or even complete fluid-proofing can be achieved. In addition, it is made possible in this way for the vibration transducer to be constructed separately from the measuring tube and that it then only has to be arranged at the measuring tube as a compact component. This can significantly simplify the manufacture and/or servicing of the measuring device.

The vibration membrane can, for example, be formed of a foil and/or have a thickness between 3 μm and 300 μm, in particular between 10 μm and 100 μm. The vibration membrane or vibration plate can consist of plastic and/or an electrically insulating material. Vibration elements can in this way for example be insulated from a conductive measuring tube. The vibration membrane or vibration plate can be bonded to the supporting device by gluing or welding, for example through ultrasonic welding or through hot stamping.

Other features which are considered as characteristic for the invention are set forth in the appended claims.

Although the invention is illustrated and described herein as embodied in a measuring device for determining a fluid variable, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

BRIEF DESCRIPTION OF THE SEVERAL VIEWS OF THE DRAWING

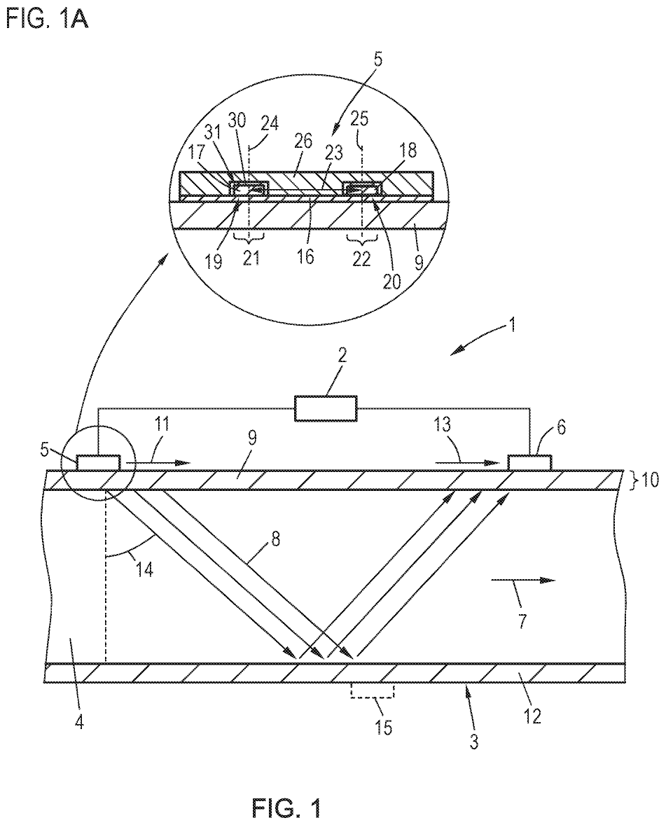

FIG. 1 is a diagrammatic, sectional view of an exemplary embodiment of a measuring device according to the invention;

FIG. 1A is an enlarged sectional view of a part of the exemplary embodiment;

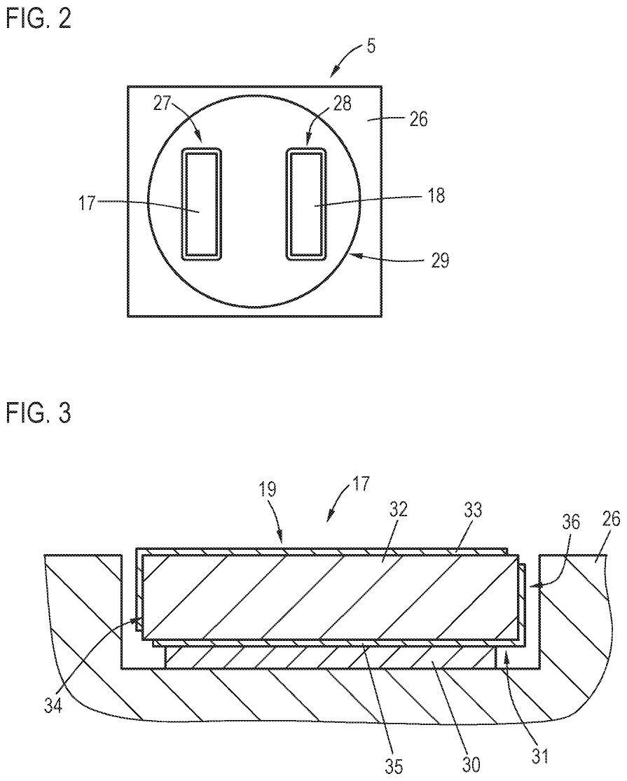

FIG. 2 is a top view of a vibration transducer of the measuring device shown in FIG. 1;

FIG. 3 is a sectional view of the vibration transducer of the measuring device shown in FIG. 1;

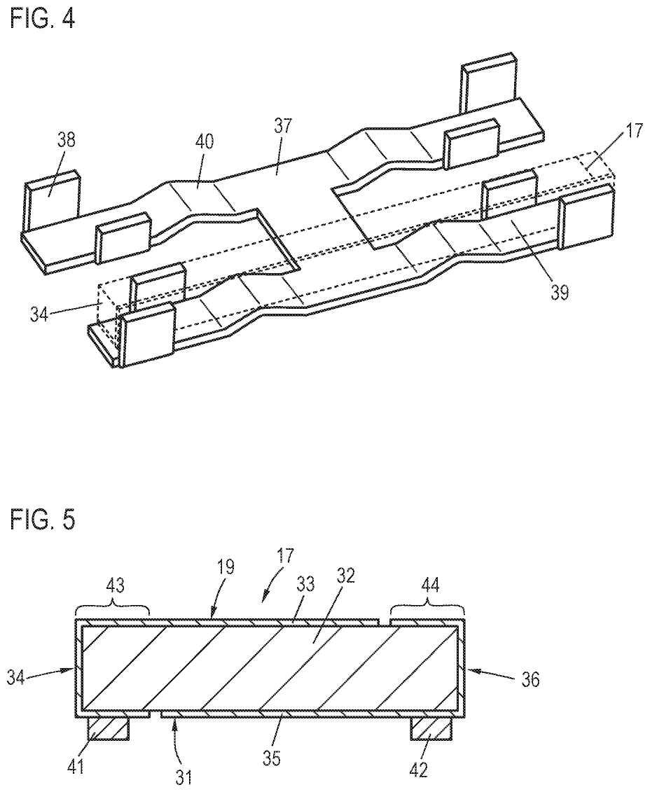

FIG. 4 is a perspective view of a further exemplary embodiment of the measuring device according to the invention;

FIG. 5 is a sectional view of another exemplary embodiment of the measuring device according to the invention;

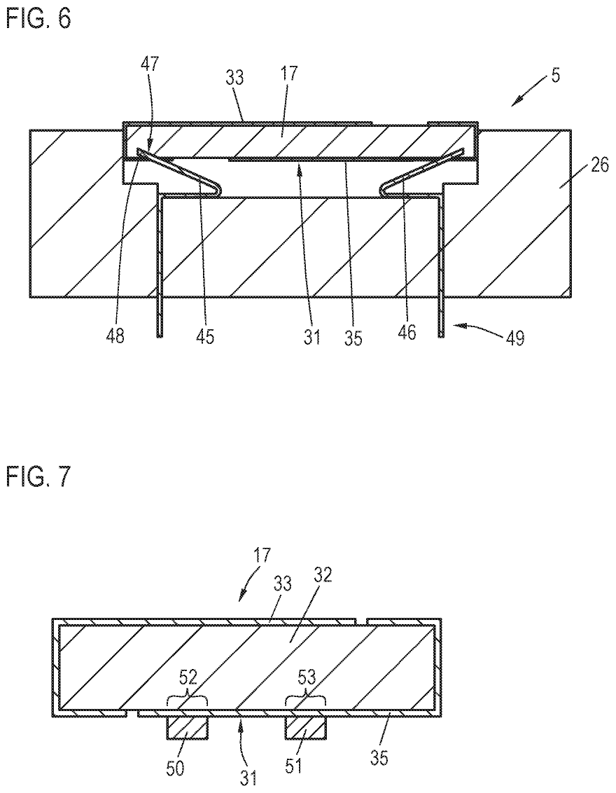

FIG. 6 is a sectional view of still another exemplary embodiment of the measuring device according to the invention; and

FIG. 7 is a sectional view of an additional exemplary embodiment of the measuring device according to the invention.

### DETAILED DESCRIPTION OF THE INVENTION

Referring now to the figures of the drawings in detail and first, particularly to FIGS. 1 and 1A thereof, there is shown a measuring device 1 for determining a fluid variable relating to a fluid and/or a fluid flow. The fluid is guided here in a direction shown by arrow 7 through an interior space 4 of a measuring tube 3. In order to determine the fluid variable, in particular a volume flow rate, a transit time difference between transit times from a first vibration transducer 5 to a second vibration transducer 6 and vice versa can be determined by a control device 2. Use is made here of the fact that this transit time depends on a velocity component of the fluid parallel to a direction of propagation through the fluid of an ultrasonic beam 8. A fluid velocity in the direction of the respective ultrasonic beam 8 averaged over the path of the respective ultrasonic beam 8 can be determined from this transit time and thereby, approximately, an averaged flow velocity in the volume crossed by the ultrasonic beam 8.

In order first to enable an arrangement of the vibration transducers 5, 6 outside the measuring tube 3 and, secondly, to reduce sensitivity in respect of different flow velocities at different positions of the flow profile, the first vibration transducer 5 does not directly introduce an ultrasonic beam 8, i.e. a pressure wave, into the fluid. A guided wave is instead excited in a side wall 9 of the measuring tube 3 by the vibration transducer 5. The excitation takes place at a frequency that is selected such that a Lamb wave is excited in the side wall 9. Such waves can be excited if a thickness 10 of the side wall 9 is comparable to the wavelength of the transverse wave in the solid body, which is given from the ratio of the sound velocity of the transverse wave in the solid body to the excited frequency.

The guided wave excited in the side wall 9 by the vibration transducer 5 is shown schematically by arrow 11. Compression vibrations of the fluid, which are radiated into the fluid in the entire propagation path of the guided wave, are excited by the guided wave. This is illustrated schematically by the ultrasonic beams 8, offset with respect to one another in the flow direction. The radiated ultrasonic beams 8 are reflected at an opposite side wall 12 and guided through the fluid back to the side wall 9. The incoming ultrasonic beams 8 there again excite a guided wave in the side wall 9, illustrated schematically by arrow 13, which can be detected by the vibration transducer 6 in order to determine the transit time. Alternatively or in addition it is possible for the radiated ultrasonic waves to be detected by a vibration transducer 15 that is arranged at the side wall 12. In the illustrated example, the ultrasonic beams 8 are either not reflected or only reflected once at the side walls 9, 12 on their path to the vibration transducer 6, 15. It would, of course, be possible to use a longer measurement segment in which the ultrasonic beams 8 are reflected multiple times at the side walls 9, 12.

It can be problematic in the procedure outlined that the dispersion relationship for Lamb waves in the side wall 9 has a plurality of branches. With excitation at a certain frequency determined by the control device 2, it would thus be possible for different vibration modes for the Lamb wave having different phase velocities to be excited. This has the result that the compression waves are radiated at different Rayleigh angles 14 depending on these phase velocities. From this, different paths, typically having different transit times, result for the guidance of the ultrasonic wave from the vibration transducer 5 to the vibration transducer 6 and vice versa. The received signals for these different propagation paths must thus be separated through a complex signal processing by the control device 2 in order to be able to determine the fluid variable. This requires, first, a complex control device and it cannot secondly be robust in all applications. The greatest possible modal purity of guided waves should therefore occur in the vibration transducer 5.

In order to achieve an excitation of a total guided wave in the side wall 9 that is largely modally pure, the vibration transducer 5 that contains a plurality of spaced vibration elements 17, 18, is used. These are driven by the control device 2 in such a way that together they excite a guided wave in the side wall 9 of the measuring tube 3. Centers 24, 25 of the excitation regions 21, 22 are here spaced apart at a fixed, predefined distance 23. Because the excitation frequency is chosen in such a way that only precisely two vibration modes of a Lamb wave can be excited in the side wall 9, and the spacing 23 and the phase relation or polarity with which the vibration elements 17, 18 vibrate is appropriately chosen, a destructive interference for an unwanted vibration mode can be ensured, so that a remaining vibration mode is excited in a substantially modally pure manner.

A correct arrangement of the vibration elements 17, 18 with respect to one another is crucial for the procedure described. The arrangement of the vibration elements 17, 18, is specified in the measuring device 1 by a supporting device 26 that is fastened to the measuring tube 3 by fastening means, not illustrated. This forms a type of housing for the vibration elements 17, 18. To ensure that side faces 19, 20 of the vibration elements 17, 18 that face the measuring tube are pressed with a defined contact pressure against the side wall 9 of the measuring tube 3, or onto the coupling element arranged between the vibration elements 17, 18 and the side wall 9, the vibration elements 17, 18, are not attached directly to the supporting device 26, for example being glued to it, but are instead supported via a respective spring element 30. The spring element 30 is clamped between side faces 31 of the respective vibration element 17, 18 that are averted from the measuring tube and the supporting device 26. When the measuring device is in the state in which it is used, in which the vibration transducer 5 is arranged at the side wall 9, it is already elastically deformed or prestressed, so that it exercises a force on the respective vibration element 17, 18.

In principle, a coupling element 16 illustrated in FIG. 1, could be omitted. The use of such a coupling element, for example a foil or a thin vibration plate, however offers first the advantage that the vibration elements 17, 18, are protected against environmental influences. Second, a supporting device 26, together with the coupling element 16, can support the vibration elements 17, 18, so that in the course of the manufacture of the measuring device, the vibration transducers 5, 6 can be assembled as separate components and arranged at the side wall 9.

The construction of the vibration transducer 5, along with details of the manufacture of the vibration transducer 5, is explained below with reference to FIGS. 2 and 3. FIG. 2 shows a view of the vibration transducer 5 before an application of the coupling element 16 to the supporting device 26. The supporting device 26 here has two recesses 27, 28, into which the vibration elements 17, 18 are inserted, in particular loosely. Because in this condition essentially no force yet acts on the side faces 19 of the vibration elements 17, 18 that face the measuring tube, the spring element 30, as illustrated in FIG. 3, is initially not yet elastically deformed or prestressed, so that the vibration elements 17, 18 initially protrude slightly above the edge of the supporting device 26. Only with the application of a sufficiently prestressed coupling element 16, or preferably only with the fastening of the supporting device to the side wall 9, is the spring element 30 compressed far enough that the vibration elements 17, 18 are pressed with a defined contact pressure against the side wall 9 or the coupling element 16, and typically are hereby substantially entirely accommodated in the respective recess 27, 28. The coupling element can, for example, be bonded to the supporting device 26 through gluing, through welding or through hot stamping. The bonding takes place in particular exclusively at the edge, as illustrated schematically through the connecting line 29. The vibration elements 17, 18 can thus be fully enclosed by the supporting device 26 and the coupling element 16 together, wherein they are in particular surrounded in a dust-proof and/or fluid-proof manner.

FIG. 3 shows, in addition, the detailed structure of a single vibration element 17. The vibration element consists of a vibration body 32, an electrode 33 on the measuring tube side, and an electrode 35 averted from the measuring tube 3. Both the electrode 33 on the measuring tube side and the electrode 35 averted from the measuring tube 3 are each taken to a further side face 34, 36 of the vibration element or of the vibration body, whereby an easier contacting, in particular of the electrode 33 on the measuring tube side is enabled while nevertheless, due to the symmetric electrode arrangement, symmetric natural vibrations of the vibration element 17 are not disturbed.

The electrical contacting of the electrodes 33, 35 is not illustrated in detail in FIG. 3. They can, for example, be made at the side faces 34, 36 by soldering or gluing them with conductive glue on appropriate lines. The electrode 35 can also be contacted by the spring element 30 if the spring element 30 is for example formed of a conductive elastomer, a conductive adhesive or the like. The manufacturing effort for manufacturing the measuring device 1 can be further reduced by contacting the electrode 35 in this sort of way.

FIG. 4 shows one possibility for mounting the vibration elements 17, 18 using a common spring element 37. A larger accommodation space of the supporting device, in which both vibration elements 17, 18 are arranged, is used here. For reasons of clarity, only the spring element 37 itself and, schematically, one of the vibration elements 17 are illustrated in FIG. 4. The spring element 37 is implemented as a stamped metal part. Stop sections 38 are formed here by bent-up straps which, after an insertion of the respective vibration element 17, 18, have a mean distance of, for example, less than 1 mm from the side faces 39 of the vibration element 17. In this way, the relative position and orientation of the vibration elements 17, 18 can be specified with little technical effort and with high precision, at least in the direction of the spacing between them.

The elastic effect of the spring element 37 is realized through elevations 40 that are produced through an appropriate bending of the stamped and bent part. These can be deformed elastically. The position of the elevations 40 is preferably selected such that they contact the respectively supported vibration element 17, 18 in a region in which vibration nodes of a natural mode of the respective vibration element 17, 18 are expected. When the measuring device is being operated for excitation of the guided wave, the vibration elements are preferably operated at an excitation frequency at which they vibrate in this natural mode. An influence of the bearing on the vibration of the vibration elements 17, 18, is hereby minimized.

Because a metallic spring element 37 is used, it is also possible to contact the electrode of the vibration elements 17, 18 averted from the measuring tube by means of the spring element 37. A predefined reference potential can, for example, be applied to the electrode 35 of both vibration elements 17, 18 that is averted from the measuring tube. The electrode 33 that faces the measuring tube can, as already explained, be contacted, for example, through the front faces 34. This for example enables an independent drive of the vibration elements 17, 18, for example in order to select a polarity of the drive, to specify a phase offset or to delay a drive signal by a certain time.

A particularly simple structure of the measuring device is possible if both electrodes 33, 35 of the vibration elements 17, 18 are contacted via a respective spring element 41, 42, as is illustrated in FIG. 5. In contrast to the exemplary embodiment illustrated in FIG. 3, the electrode 33 that faces the measuring tube is drawn onto the side face 31 averted from the measuring tube, and the electrode 35 averted from the measuring tube is drawn on to the side face 19 that faces the measuring tube. This makes it possible to contact both electrodes via the side face 31 averted from the measuring tube with a substantially symmetric electrode arrangement, and thus with only slight disturbance to the natural vibrations of the vibration body 32. In FIG. 5 the contacting takes place through conductive spring elements 41, 42 which can, for example, be formed of a conductive polymer or plastic. The spring elements 41, 42 here exclusively contact the side faces 31 in the edge regions 43, 44 in which respectively the same electrodes 33 or 35 is arranged on both side faces 19, 31. This has the effect that even when a voltage is applied between the electrodes 33, 35, the field strengths in the edge regions 43, 44 are very small, as a result of which also only very small vibration amplitudes occur there. This reduces, first, the influence of the bearing by way of the spring elements 41, 42 on the vibration behavior of the vibration element 17, and secondly coupling of vibration into the supporting device 26 can hereby be significantly reduced.

The spring elements 41, 42 can already be arranged at the vibration element 17 in a preparatory working step before the latter is inserted into the supporting device 26. The vibration element 17 can, for example, be given an elastomer or a layer of adhesive in the illustrated regions. This, first, simplifies the assembly of the measuring device. Second, an intended alignment of the vibration element 17 during installation into the supporting device 26 is hereby made clearly recognizable, whereby an installation with incorrect polarity can, for example, be avoided.

The arrangement of the electrodes 33, 35 and spring elements 41, 42 shown in FIG. 5 can also be advantageous when the electrodes 33, 35, are not contacted by way of the spring elements 41, 42 since the previously described advantages of the arrangement of the spring elements 41, 42 in the edge regions 43, 44 continue to apply.

The mounting of the vibration element 17 by means of the spring elements 45, 46 illustrated in FIG. 6 largely corresponds to the mounting illustrated in FIG. 5, but instead of blocks of elastic material, metal sheet springs are used as spring elements 45, 46. These can, for example, be cast into the supporting device 26 or inserted into this in a preceding working step. The use of such spring elements 45, 46 enables a particularly simple contacting, since simple contacting is possible at, for example, an end 49 of the metal sheet brought out from the supporting device 26. The spring elements 45, 46 each have a recess 47 which can, for example, be stamped into the corresponding metal sheet. This has the result that supporting sections 48 that extend over and beyond a contact section of the spring elements 45, 46 that lies against the side face 31 averted from the measuring tube form stop sections, as was already explained with reference to FIG. 4. In this way, the position of the vibration element 17 perpendicular to the plane of the drawing is also specified by the spring elements 45, 46.

FIG. 7 shows a further possibility for the elastic mounting of the vibration element 17. Spring elements 50, 51 can here again for example be formed of blocks of an elastic material, for example rubber or another elastomer, and optionally also be conductive, in order to contact the electrode 35. The spring elements 50, 51 contact the side faces 31 averted from the measuring tube of the vibration element 17 in two separated contact regions 52, 53 which, as was already explained in respect of FIG. 4, are each arranged in regions of a vibration node of a natural vibration of the vibration element 17.

### LIST OF REFERENCE SIGNS

1 Measuring device
2 Control device
3 Measuring tube
4 Interior space
5 Vibration transducer
6 Vibration transducer
7 Arrow
8 Ultrasonic beam
9 Side wall
10 Thickness
11 Arrow
12 Side wall
13 Arrow
14 Rayleigh angle
15 Vibration transducer
16 Coupling element
17 Vibration element
18 Vibration element
19 Side face
20 Side face
21 Excitation region
22 Excitation region
23 Distance
24 Center
25 Center
26 Supporting device
27 Recess
28 Recess
29 Connecting line
30 Spring element
31 Side face averted from the measuring tube
32 Vibration body
33 Electrode
34 Side face
35 Electrode
36 Side face
37 Spring element
38 Stop section
39 Side face
40 Elevation
41 Spring element
42 Spring element
43 Edge region
44 Edge region
45 Spring element
46 Spring element
47 Recess
48 Supporting section
49 End
50 Spring element
51 Spring element
52 Contact region
53 Contact region

1. A measuring device for determining a fluid variable relating to a fluid and/or a fluid flow of the fluid, the measuring device comprises:
a controller;
a measuring tube serving to accommodate and/or guide the fluid and having a side wall;
vibration transducers including a first vibration transducer and a second vibration transducer, said first vibration transducer disposed at said measuring tube, said first vibration transducer having a supporting device in a location that is fixed with respect to said measuring tube, at least two vibration elements spaced apart from one another, and elastically deformed spring elements each clamped between a respective side face of one of said vibration elements averted from said measuring tube and said supporting device, said elastically deformed spring elements pressing said vibration elements against said measuring tube or a coupling element disposed between said measuring tube and said vibration elements; and
said controller configured to drive said vibration elements in such a way that together said vibration elements excite a guided wave in said side wall of said measuring tube that can be guided directly in said side wall or indirectly via the fluid to said second vibration transducer disposed at said measuring tube or back to said first vibration transducer, in order to be detected there by said controller for a determination of measurement data, and said controller device configured to determine the fluid variable depending on the measurement data.

2. The measuring device according to claim 1, wherein:
at least one of said vibration elements has a measuring tube side, a vibration body with a first side face and a second side face, a first electrode disposed on said first side face of said vibration body on said measuring tube side, and a second electrode averted from said measuring tube that is disposed at said second side face of said vibration body averted from said measuring tube on an opposite side to said measuring tube side, wherein said first electrode on said measuring tube side extends over a further side face of said vibration body that is angled with respect to said first and second side faces on said measuring tube side and averted from said measuring tube; and
said controller is configured to vary a voltage between said first and second electrodes on said measuring tube side and averted from said measuring tube in order to excite said vibration body into vibration.

3. The measuring device according to claim 2, wherein said first electrode on said measuring tube side extends over said further side face as far as said second side face averted from said measuring tube.

4. The measuring device according to claim 2, wherein said first electrode or said second electrode is electrically contacted by one of said elastically deformed spring elements that is electrically conductive.

5. The measuring device according to claim 4, wherein at least one of said elastically deformed spring elements electrically contacts precisely one of said first or second electrodes of precisely one of said vibration elements.

6. The measuring device according to claim 2, wherein:
said vibration body is rectangularly shaped vibration body;
said first and second side faces on said measuring tube side and averted from said measuring tube are spanned by a longitudinal direction and a transverse direction of said rectangle;
said vibration body has a first edge region at a first edge in the transverse direction and a second edge region at a second edge positioned opposite said first edge, in said first edge region only said first electrode on said measuring tube side is disposed both at said first side face on said measuring tube side and at said second side face averted from said measuring tube, and in said second edge region only said second electrode averted from said measuring tube is disposed both at said first side face on said measuring tube side and at said second side face averted from said measuring tube; and
a respective one of said elastically deformed spring elements mechanically contacts said respective side face of said vibration elements averted from said measuring tube in said first and second edge region.

7. The measuring device according to claim 1, wherein:
said vibration elements each have a plurality of spaced contact regions; and
one of said elastically deformed spring elements contacts said respective side face of a respective one of said vibration elements averted from said measuring tube at said plurality of spaced contact regions, wherein said spaced contact regions are each disposed in a region of a vibration node of a natural vibration of said respective vibration element.

8. The measuring device according to claim 1, wherein at least one of said elastically deformed spring elements and/or said supporting device contains at least one stop section that mechanically contacts one of said vibration elements on at least one side face of said one vibration element that is angled with respect to said respective side face of said one vibration element averted from said measuring tube, and/or that limits a movement of said one vibration element perpendicularly to said side face at least on one side.

9. The measuring device according to claim 8, wherein said one elastically deformed spring element has a recess formed therein and into said recess one of said vibration elements is inserted in such a way that a contact section of said elastically deformed spring element lies against said respective side face of said one vibration element averted from said measuring tube, and that at least one supporting section of said one elastically deformed spring element that extends in a direction of said measuring tube over and beyond said contact section forms said stop section.

10. The measuring device according to claim 1, wherein said elastically deformed spring elements are formed of a polymer, or an elastomer, or a metal, or comprises an adhesive layer or is an adhesive layer.

11. The measuring device according to claim 1, wherein:
said first vibration transducer has a vibration membrane or a vibration plate as said coupling element that is fastened to said supporting device and coupled to said measuring tube directly or via a coupling layer;
a respective one of said vibration elements is disposed at a surface of said vibration membrane or said vibration plate averted from said measuring tube at mutually spaced excitation regions; and
said vibration elements are supported jointly by said elastically deformed spring elements and said vibration membrane or said vibration plate.
